(19) United States
(12) Patent Application Publication
(10) Pub. No.: US 2017/0113374 A1
(43) Pub. Date: Apr. 27, 2017

(54) ASSEMBLY LINE FOR CREATING A RECYCLABLE AND EXTRUDABLE PALLET ARTICLE WITH WOOD AND PLASTIC COMPONENTS

(71) Applicant: Oria Collapsibles, LLC, Auburn Hills, MI (US)

(72) Inventor: Miguel A. Linares, Bloomfield Hills, MI (US)

(21) Appl. No.: 15/401,364

(22) Filed: Jan. 9, 2017

Related U.S. Application Data
(62) Division of application No. 14/675,141, filed on Mar. 31, 2015.
(60) Provisional application No. 61/973,570, filed on Apr. 1, 2014.

(51) Int. Cl. B27N 3/02; B05D 3/02; B05D 7/06; B27N 3/18; B27N 3/28; B05D 1/02; B05D 3/12; B27N 1/02

(52) U.S. Cl. CPC B27N 3/02; B05D 3/12; B05D 3/0254; B27N 1/02; B27N 3/18; B27N 3/28; B05D 1/02; B05D 7/06

(57) ABSTRACT

A manufacturing assembly line for producing an article including a first spray coating station for applying a plastic spray coating to an existing wooden pallet, a second grinding or pulverizing station for reducing the coated article into finely ground particles of a uniform dimension, and a third heating station for converting the mixture into a molten or flowable state. The assembly line further includes a fourth extruder station for forcing the mixture at pressure through an extruder die aperture of a selected cross sectional configured extruder, and so that the mixture is reformed as an elongated article and a fifth cutting station for sectioning the extruded article into selected lengths for subsequent attachment or securernent into a desired configuration.

### CROSS REFERENCE TO RELATED APPLICATIONS

This application is a divisional application and claims the benefit of U.S. Ser. No. 14/675,141 filed Mar. 31, 2015. The 14/675,141 application in turn claims the benefit of U.S. Ser. No. 61/973,570 filed on Apr. 1, 2014, the contents of which are incorporated herein in its entirety.

### FIELD OF THE INVENTION

The present invention discloses improvements to known pallet assemblies, such as depicted in U.S. Pat. No. 8,438,981 to Linares. In particular, the invention discloses an article and process for producing a recyclable and extrude-able product. In one non-limiting application, an existing wood constructed article, such as a pallet, is initially sprayed or otherwise coated with a plasticized material in a fluidic state. Upon setting, the pallet or like wood coated article is then ground or pulverized in a fashion such that the wood and plasticized components are reduced to a fine and intermixed particulate. The ground material can then be reheated and converted to a fluidic state, such potentially accompanied by the addition of a binder material or other fluidic component. Following this, the reconstituted material is forced through an extruder and reformed as elongated beams or members, such capable of being assembled as a reconstructed pallet or other endurable article.

### BACKGROUND OF THE RELEVANT ART

The prior art teaches a variety of pallet related designs and constructions. A first example of these is the pallet design with buoyant characteristics, as depicted in U.S. Pat. No. 8,438,981 to Linares, and which teaches a three dimensional shaped and buoyant inducing body with enhanced load supporting capabilities. The body exhibits a rectangular profile and is constructed of at least one of a corrugated paperboard, plastic or composite material and coated with a plasticized spray.

An inner core defined within a three dimensional interior of the body is constructed of any plural arrangement of inner extending, interconnected and frame defining components, at least one of the components and/or the outer surfaces being coated with a plasticized spray. The inner constructed core can further include any of a structural paperboard, bamboo, other tubular material, or structural foam. In a further variant, a standard pallet design of upper and lower cross pieces separated by spaced apart bridge pieces is provided, and in which the individual members are each configured with structurally defined inner cores according to any of the above constructions.

FR 2922194 discloses a handling pallet which has legs each comprising sections such as longeron or lower section and traverse or upper section, obtained by folding/rolling sheets of a cardboard and/or made of a molded plastic and reconstituted wood materials. The sections comprise a side to rest on a ground surface while other side presents detenting and reception units. The units comprise two opposite diametric recesses, a triangular shaped seat and a complementary shaped recess. The units are conformed to allow subjection of the sections at a level of intersection of the sections.

JP 2004/182413 teaches a plastic reinforced wooden drum, and a recycling method for waste wood and plastic materials. According to the manufacturing method, a waste drum or waste pallet is disposed of by being crushed by a crusher into fine splinters of several millimeters to several centimeters square. A plastic material is added to the splinters using a hopper, and the mixture is kneaded by a kneader. The kneaded mixture is molded through press working or injection moulding into a plate form material, and such plate-form materials are assembled so that the intended plastic-reinforced wooden drum is erected. Otherwise a complete item of plastic-reinforced wooden drum may be yielded by molding the kneaded mixture by an injection molding machine.

### SUMMARY OF THE PRESENT INVENTION

The present invention discloses a three dimensional shaped article formed from a grounded or pulverized wood and plasticized matrix, extruded into elongated sections, and post assembled to form a body. The body in a desired application further includes a pallet shaped article adapted to provide increased load bearing capabilities for a cargo placed upon the body.

The body further includes a rectangular profile which can be post-coated with a plasticized spray. At least one of the elongated extruded sections further incorporates an inner core defined within a three dimensional interior of the body and including a plurality of inner extending, interconnected and frame defining components, at least one of the components being coated with a plasticized spray.

The core may include at least one of a structural paperboard, bamboo, other tubular material, or structural foam. The body further incorporate a plurality of vertical extending cutout portions extending between top and bottom surfaces of and adapted to facilitate drainage of fluid entrapped within the body.

Also disclosed is a process for creating an extruded product, including the steps of applying a plasticized coating to an existing wooden or other cellulose based article and grinding or pulverized the article into finely ground particles of a suitable and uniform dimension. Additional steps include heating the mixture into a molten or flowable state, forcing the mixture at pressure through an extruder die aperture of a selected cross sectional configured extruder, and so that the mixture is reformed as an elongated article; and sectioning the extruded article into selected lengths for subsequent attachment or securement into a desired configuration. Yet additional steps include combining, into the ground or pulverized article and prior to heating, an additive not limited to another plasticized component or other binder, such as provided in any of a pellet, liquid and/or granular form.

A related manufacturing assembly line is disclosed for producing an article and includes a first spray coating station for applying a plastic spray coating to an existing wooden pallet. A second grinding or pulverizing station reduces the coated article into finely ground particles of a uniform dimension, with a third heating station for converting the mixture into a molten or flowable state.

A fourth extruder station forces the mixture at pressure through an extruder die aperture of a selected cross sectional configured extruder, and so that the mixture is reformed as an elongated article. A fifth cutting station sections the extruded article into selected lengths for subsequent attachment or securement into a desired configuration. Also disclosed is a fifth material additive station interposed between the second and third stations for combining, into the ground or pulverized article and prior to heating, an additive not limited to another plasticized component or other binder, such as provided in any of a pellet, liquid and/or granular form.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of a standard wooden pallet coated with a spray plasticized material of either known or proprietary (trade secret) formula or composition;

FIG. 2 is a cutaway view of a selected wood pallet member coated with the proprietary (trade secret) plasticized composition;

FIG. 3 is an example of a recycled and extruded product reconstituted from the grinding/pulverizing of the pallet in FIGS. 1-2, and reassembled into the article shown according to one non-limiting construction;

FIG. 4 is an illustration of a further pallet article produced according to reconstructed extruded process disclosed in the present invention;

FIG. 5 is a perspective illustration of another pallet construction produced according to the present invention and in which handling and drainage holes are configured through its depth, combined with edge projecting stacking locators defined along each side;

FIG. 6 is a succeeding illustration of the pre-ground and post-extruded pallet of FIG. 5, exhibiting its reversible nature such that it can be employed with either side facing upward, the extruded pallet further capable of being coated with a further plasticized spray or sealant in order to provide environmental and anti-microbial protection against wood degradation, fire resistant properties, and to avoid weight increase due to entrained water;

FIG. 7 is a flow diagram of one variant of the process of the invention for reconstituting an existing wooden article/pallet into a finish extruded and post-assembled product; and

FIG. 8 is a related assembly line process for creating the existing wooden article or pallet.

### DETAILED DESCRIPTION OF THE PREFERRED EMBODIMENTS

The present invention discloses improvements to pallet articles, such as previously disclosed in U.S. Pat. No. 8,438,961, to Linares, the disclosure of which is hereby incorporated by reference. In particular, the present invention discloses each of an article, assembly and process for reconstituting an existing pallet or other wooden article, including the steps of coating the existing wooden article with any known or trade secret/proprietary plasticized spray composition, and post grinding/pulverizing the coated article into a grounded and intermixed particulate.

Additional steps include adding any needed binder or other ingredient, reheating the reconstituted mixture to reduce the same to a molten/flowable form and forcing the mixture through an extruder in order to form elongated articles of desired cross sectional profile. The extruded article can be sectioned and reassembled in the manner desired to create a finished product, such as in one non-limiting application a pallet article of superior environmental resistant and performance characteristics. Other features such as post-applied coatings and the like are also envisioned in application to the finished article.

The present invention further contemplates the ability to produce a number variations of improved pallet or other extruded and assemble able article exhibiting any one or more of moisture sealant, fire retardant and buoyant characteristics. As depicted in the underlying U.S. Pat. No. 8,438,981 patent, such articles can include the incorporation of inflatable bladders for providing combined cargo supporting and buoyancy aspects upon a body of water such as during being launched from a ship or dropped from an aircraft. It is further understood that the present invention, while providing buoyancy inducing aspects suitable for supporting a load upon a body of water, is not strictly limited to seaborne applications and the pallet variants described herein are operable in any environment in which enhanced load bearing and environmentally resistive capabilities are sought.

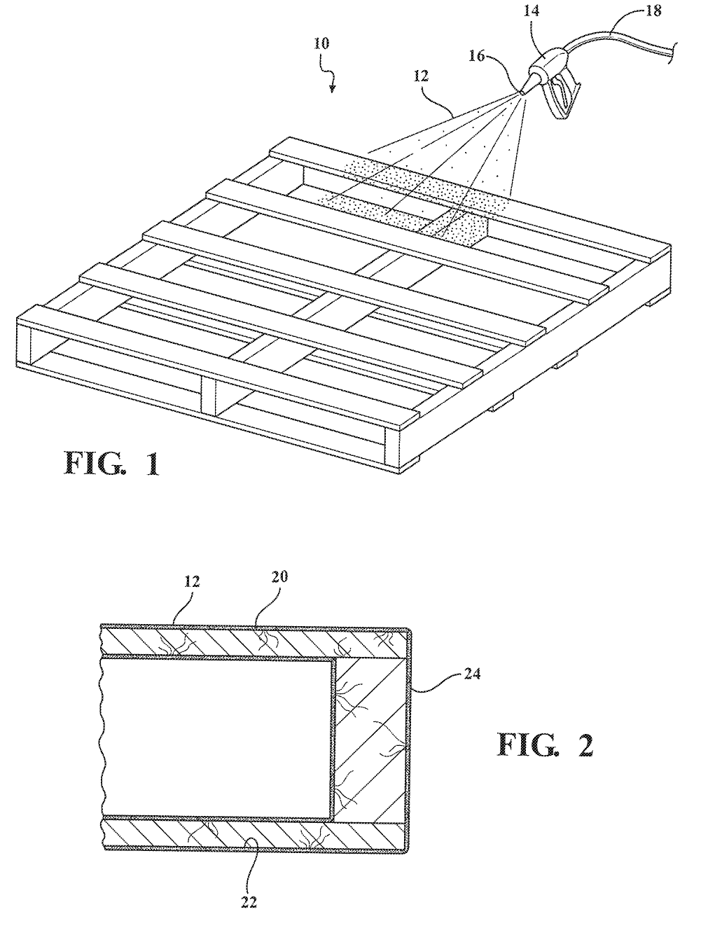

Referring to FIG. 1, a perspective illustration is generally shown at 10 a standard wooden pallet which is in the process of being coated with a spray plasticized material, see at 12, such as applied by a gun 14 with spray nozzle 16 and which can be further fed from a hose or tube 18 drawing the material in a flowable form from a remote reservoir (not shown). The present invention contemplates the plasticized material including any type of either known or proprietary (trade secret) formula or composition, such potentially further including the addition of other components not limited to aggregates or other types of particulate matter. As is further known, the application process can include any of an atomized spray deposition (shown), as well as coating or injection molding processes which can be employed for pre-coating the pallet or other suitable wooden article.

FIG. 2 is a cutaway view of a selected wood pallet member, such as shown in FIG. 1, and which includes such as top 20, bottom 22 and intermediate cross members 24 which are is coated with the proprietary (trade secret) plasticized composition 12. While it is further understood that the wooden pallet 10 or the like can include any existing article such as at the end of its useful life, it is also envisioned that any type of new or scrap wooden material can be repurposed in this fashion.

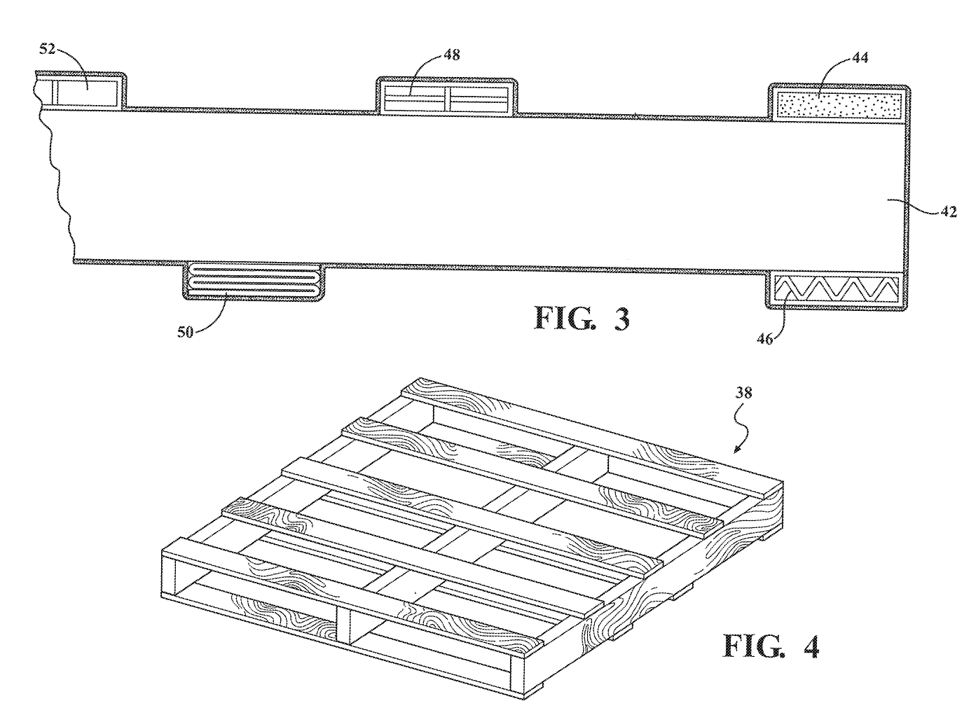

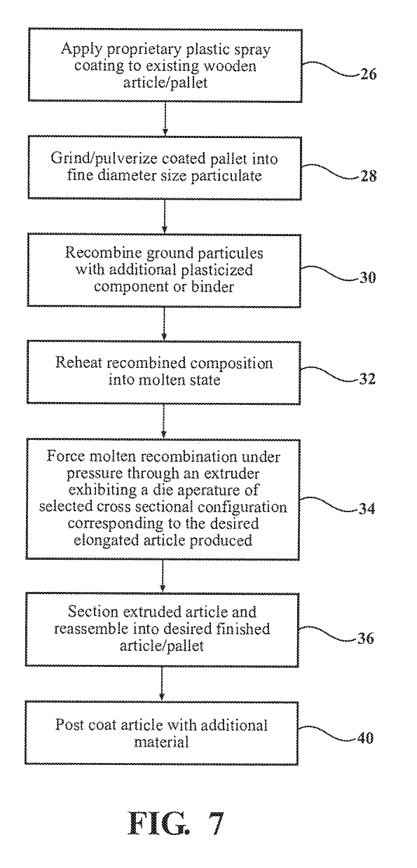

FIG. 7 is a flow diagram of one variant of the process of the invention for reconstituting an existing and plasticized coated wooden article/pallet 10 into a finish extruded and post-assembled product (as further described in FIGS. 3-6). In a most basic application, the proprietary or other plasticized coating is applied in a first step at 26 to the existing wooden (or other cellulosic based) article or pallet (e.g. again at 10). At succeeding step 28, the plasticized coated wooden pallet or like article is pulverized into finely ground particles, the understanding being that any suitable machinery known in the art can be employed for reducing the article to a sufficiently smaller and uniformly sized diameter which facilitates subsequent repurposing.

At step 30, the pulverized and mixed matrix of wood and plastic is optionally combined with any other additive not limited to an additional plasticized component or other binder, such as provided in any of a pellet, liquid and/or granular form. It is also understood that, based upon the proprietary coating pre-applied to the wooden article, no further additives may be required at this step.

At succeeding step 32, the (recombined or not) mixture is heated into a molten or flowable state and, at succeeding step 34, the mixture is forced at pressure through a die aperture of a selected cross sectional configured extruder and so that the mixture is reformed as an elongated article. At step 36, the extruded article is sectioned or otherwise incised into selected lengths for subsequent attachment or securement into a desired configuration, such as reflected by pallet article 38 generally depicted in FIG. 4. At step 40, the article can be optionally coated or post applied with another material such as to provide additional sealing or other environmental characteristics. Without limitation, it is also envisioned and understood that the process of the present invention is not limited to producing a pallet article, however can also produce any other three dimensional article or construction utilizing the ability to coat, grind, melt and extrude the materials described herein.

FIG. 3 is an example of another recycled and extruded product reconstituted from the grinding/pulverizing of the pallet in FIGS. 1-2, and reassembled into the article shown according to one non-limiting construction which can include a main member 42 with upper and lower alternating cross pieces 44, 46, 48, 50, 52, et seq., these being of varying composition within the boundaries of what is possible with the present invention.

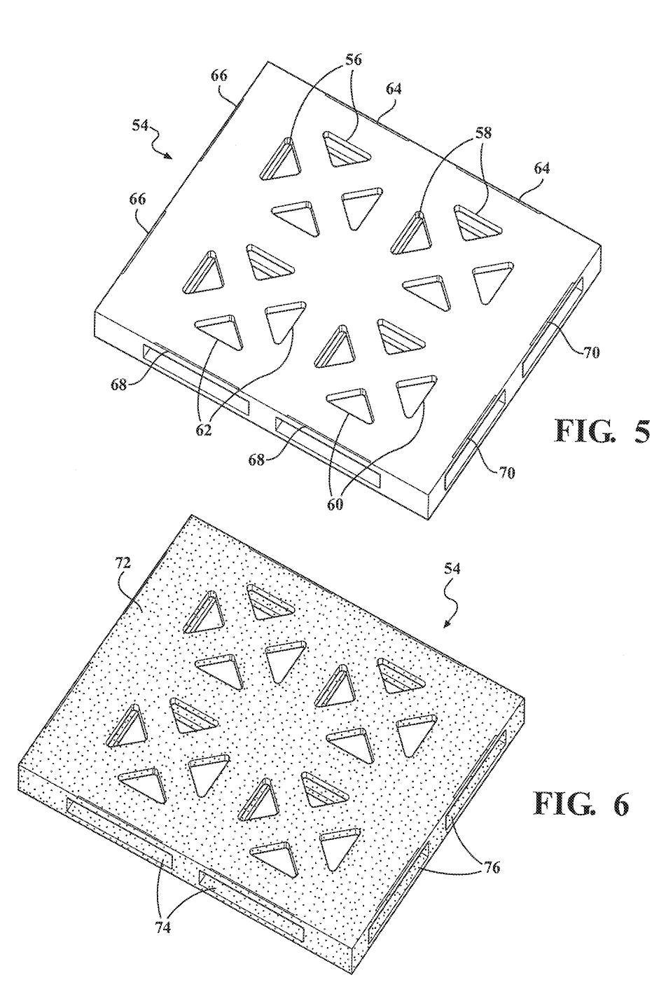

FIGS. 5 and 6 are first and second reversible illustrations in perspective of another pallet construction, generally at 54, produced according to the present invention and in which handling and drainage holes (see pluralities of triangular shaped perimeter configurations 56, 58, 60 and 62) are configured through a depth of the pallet 54, combined with edge projecting stacking locators 64, 66, 68 and 70 defined along each side, these further including raised or other elongated protuberances or the like for seating with opposing and recessed underside extending edge locations (not shown) of a further identically configured and underside stacked pallet.

FIG. 6 is a succeeding illustration of the pre-ground and post-extruded pallet of FIG. 5, exhibiting its reversible nature such that it can be employed with either side facing upward, the extruded pallet further capable of being coated with a further plasticized spray or sealant, at 72, in order to provide environmental and anti-microbial protection against wood degradation, fire resistant properties, and to avoid weight increase due to entrained water. Additional spaced apart aperture pairs, see at 74 and 76 in FIG. 6, can be integrated into the sides of the pallet for facilitating insertion of lift forks.

Additional features also envisioning combining into the extruded materials such other components not limited to structural paperboard, bamboo, other tubular material, or structural foam and in order to modify further the performance characteristics of the finished article. Beyond that disclosed, it is also envisioned and understood that the coating protocols described herein can include, but are not limited to, pre-coating applications applied to each of wooden or even grounded paperboard or cardboard material (or possibly both in combination), such prior to the ground and molten composition being reformed into the individually extruded and elongated three dimensional bridging or separating pieces.

The coating options alternatively or additionally include applying to all of the exterior surfaces of the eventually reformed pallet, either or all of before, during and/or after finished assembly, this again in order to provide both waterproofing and mildew, anti-microbial resistance, the lack of such otherwise tending to cause the paperboard material to gain significant weight through the entrainment of water, as well as degrading its weight bearing properties and useful life.

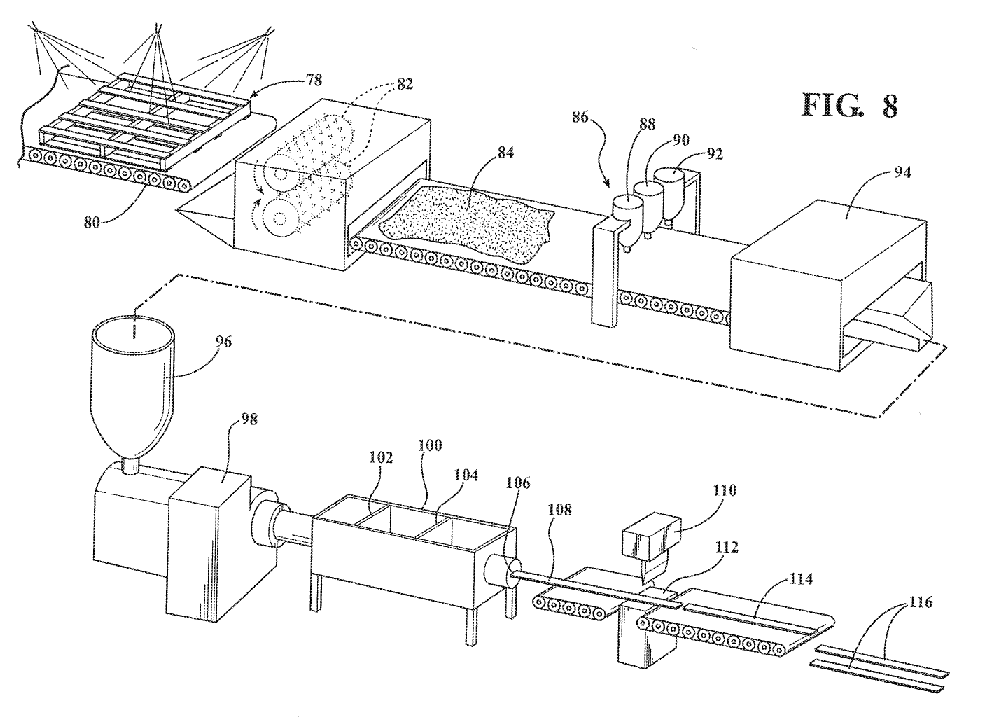

Finally, and referring to FIG. 8, a related assembly line process is shown for creating the existing wooden article or pallet. A plurality of stations are provided and include a coating station 78 for applying a plastic spray coating to an existing wooden pallet 79 or other existing article.

The spray coating station can include any plurality of fixed spray nozzles (such as which can be controlled by a servo robotic arm or are fixed) and which apply a desired volume of a plastic material to the exterior of the wooden article according to a built up thickness. For purposes of efficiency, an optional drying/curing station (not shown) can be provided for drying the coated article. Alternatively, the plastic coated pallets/articles can be left to dry for a suitable period of time before proceeding to the next station.

Following the first station according to the above dictates, a conveyor or other transfer apparatus (see in reduced section at 82) advances the coated pallet to a second grinding or pulverizing station 82 for reducing the coated article into finely ground particles 84 of a uniform dimension. An optional material additive station 86 is positioned following the grinding/pulverizing station 82 and a further heating station 88. The material additive station 86 combines another plasticized component or binder, not limited to any of a pellet 88, liquid 90 and/or granular 92 volumetric input, into the ground or pulverized article.

A heating station 94 converts the mixture into a molten or flowable state 96. The molten fluid 96 is pumped, via suitable piping and valving structure 98 into a fourth extruder station 100, such including a series of sizing die plates 102 and 104 for forcing the mixture at pressure through an extruder die aperture, see at outlet location 106, of a selected cross sectional configured extruder, and so that the mixture is reformed as an elongated continuous article 108. Finally, a fifth cutting station, see crosswise advancing blade 110 and anvil surface 112, provides for sectioning the continuous extruded article into selected lengths, at 114, 116, et seq., for subsequent attachment or securement into a desired configuration.

Having described my invention, other and additional preferred embodiments will become apparent to those skilled in the art to which it pertains, and without deviating from the scope of the appended claims.

I claim:

1. A manufacturing assembly line for producing an article, comprising:
a first spray coating station for applying a plastic spray coating to an existing wooden pallet;
a second grinding or pulverizing station for educing the coated article into finely ground particles of a uniform dimension;
a third heating station for converting the mixture into a molten or flowable state;
a fourth extruder station for forcing the mixture at pressure through an extruder die aperture of a selected cross sectional configured extruder, and so that the mixture is reformed as an elongated article; and
a fifth cutting station for sectioning the extruded article into selected lengths for subsequent attachment or securement into a desired configuration.

2. The manufacturing assembly of claim 1, further comprising an additional material additive station interposed between said second and third stations for combining, into the ground or pulverized article and prior to heating, an additive not limited to another plasticized component or other binder and provided in any of a pellet, liquid or granular form.

3. The manufacturing assembly of claim 1, the first spray coating station further comprising a plurality of spray nozzles.

4. The manufacturing assembly of claim 3, further comprising said spray nozzles being either fixed or supported by servo robotic arms.

5. The manufacturing assembly of claim 3, further comprising a curing station between the spray coating and grinding stations for drying the spray coated pallet.

6. The manufacturing assembly of claim 1, further comprising a piping and valve structure extending between the heating and extruding stations and including a pump to direct the flowable mixture into the extruder station.

7. The manufacturing assembly of claim 1, said extruder station further comprising a series of spaced sizing die plates.

8. The manufacturing assembly of claim 1, the fifth cutting station further comprising crosswise advancing blade and anvil surface for sectioning the continuous extruded article into selected lengths.

9. The manufacturing assembly of claim 1, further comprising an additional post coating station following said fifth cutting station.
